(19) United States
(12) Patent Application Publication
(10) Pub. No.: US 2009/0171626 A1
(43) Pub. Date: Jul. 2, 2009

(54) Integrated Engineering Analysis System

(76) Inventors: Zaineddin S. Dweik, Hamilton, OH (US); James Carlton Dudley, Cincinnati, OH (US); Robert N. Pittman, Fairfield, OH (US); Amid Ansari, Mason, OH (US)

Correspondence Address: GENERAL ELECTRIC COMPANY, GE AVIATION, ONE NEUMANN WAY MD H17, CINCINNATI, OH, 45215, US

(21) Appl. No.: 11/965,381

(22) Filed: Dec. 27, 2007

(51) Int. Cl. G06G 7/64; G06F 17/50; G06G 7/56

(52) U.S. Cl. 703/1; 703/8; 703/7; 703/6

(57) ABSTRACT

An integrated engineering analysis system comprises: a) a first integrated computational process, the first process being comprised of a plurality of computational solvers adapted to compute characteristics of a first component; b) a second integrated computational process, the second process being comprised of a plurality of computational solvers adapted to compute characteristics of a second component; and c) communication paths between corresponding computational solvers of the first and second computational processes.

### BACKGROUND OF THE INVENTION

The technology described herein relates to systems for performing integrated engineering analyses.

In highly complex engineering situations where the final product or design has a numerous amount of interrelated mechanical parts and/or functions, the engineering design process consists of a plurality of independent modeling problems wherein the solution of each of the modeling problems is determined by running a series of simulations or solving a series of problems whereby the solution of the first simulation and/or problem is inputted into the next simulation and/or problem until the variance between the last solution and the second to last solution is at a minimum and/or within predetermined tolerances.

However, and in design problems where there is a plurality of independent modeling scenarios and each of the inputs and/or outputs of the scenarios is related to or has a significant effect on the result of one or more of the other scenarios, the solution process is quite tedious and cumbersome.

For example, an ideal input for a first simulation may result in an unacceptable result for a second simulation. Accordingly, and in situations where each of the modeling scenarios is run in a “stand alone” process, the simulations must be reexecuted until each one of the simulations results in an output which is within the predetermined tolerances of the design.

For example, in designing an aircraft engine, and for purposes of illustrating just one problem encountered in such a design, the reliability, weight, performance, and, ultimately, the life of rotating turbo-machinery in an aircraft engine is inherently dependent upon the operating temperature distributions within the components of the machine. The determination of these operating temperatures is very complex. In order to determine these temperatures, the calculation of the values of many independent parameters that are the results of individual subprocesses themselves, must be determined.

Although engineering analysis systems and processes have been developed which integrate the analysis subprocesses for a given component, there remains a need for engineering analysis systems and processes that account for interdependencies among multiple adjacent and/or interactive components.

### BRIEF DESCRIPTION OF THE INVENTION

In one aspect, an integrated engineering analysis system is described. The system comprises: a) a first integrated computational process, the first process being comprised of a plurality of computational solvers adapted to compute characteristics of a first component; b) a second integrated computational process, the second process being comprised of a plurality of computational solvers adapted to compute characteristics of a second component; and c) communication paths between corresponding computational solvers of the first and second computational processes.

### BRIEF DESCRIPTION OF THE DRAWINGS

The accompanying drawings illustrate several embodiments of the technology described herein, wherein:

FIG. 1 is a block diagram of an integrated engineering analysis process in an exemplary embodiment of the present invention; and

FIG. 2 is a block diagram of an intended use of the integrated engineering analysis process of FIG. 1; and

FIG. 3 is a block diagram of an integrated engineering analysis system and process in accordance with an exemplary embodiment of the present invention.

### DETAILED DESCRIPTION OF THE INVENTION

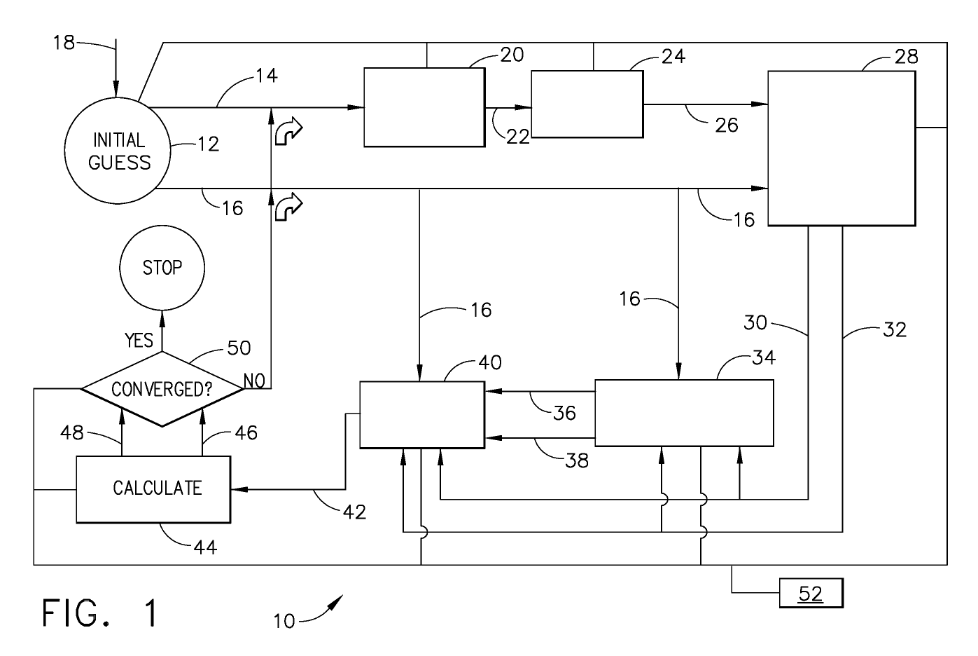

Referring now to FIG. 1, an integrated engineering analysis process 10 with solution feedback is illustrated. An initial guess or estimate 12 provides a first initial value 14 and a second initial value 16. Initial estimate 12 determines values 14 and 16 in response to a first condition 18 which is either inputted into initial estimate 12 or is a component part of initial estimate 12 which determines initial values 14 and 16.

A first subprocess 20 receives a first initial value 14 and provides an output 22. Output 22 is dependent upon the value of first initial value 14. First subprocess 20 can be or include a computer algorithm which receives an input in the form of first initial value 14 and accordingly calculates output 22.

A second subprocess 24 receives output 22 and provides an output 26. Output 26 is dependent upon the value of output 22. Second subprocess 22 can be or include a computer algorithm which receives an input in the form of output 22 and accordingly calculates output 26.

A third subprocess 28 receives output 26 and second initial value 16 and provides outputs 30 and 32. Output 30 and 32 are dependent upon output 26 and second initial value 16. Third subprocess 28 can also be or include a computer algorithm that receives inputs in the form of output 26 and initial value 16 which in response to the values of the output 26 and value 16 provides outputs 30 and 32.

A fourth subprocess 34 receives second initial value 16 and outputs 30 and 32. Fourth subprocess 34 produces outputs 36 and 38. Outputs 36 and 38 are dependent upon second initial value 16 and outputs 30 and 32. In addition, fourth subprocess 34 can also be or include a computer algorithm that receives inputs in the form of initial value 16 and outputs 30 and 32. In response to these inputs fourth subprocess 34 calculates and provides outputs 36 and 38.

A fifth subprocess 40 receives second initial value 16 and outputs 30, 32, 36, and 38. Fifth subprocess 40 produces a final output 42. Final output 42 is dependent upon second initial value 16 and outputs 30, 32, 36, and 38. Similarly, fifth subprocess 40 can be or include a computer algorithm which in response to initial value 16 and outputs 30, 32, 36, and 38 calculates a final output 42.

Final output 42 is now inputted into a final subprocess 44. Final subprocess 44 produces outputs 46 and 48. Outputs 46 and 48 are dependent upon the value of final output 42. Final subprocess 44 can also be or include a computer algorithm which in response to the value of final output 42 calculates outputs 46 and 48. Outputs 46 and 48 correspond to initial values 14 and 16 respectively. For example, initial value 14 is determined by the initial estimation and output 46 is a value that is comparable to initial value 14; however, output 46 is determined by a series of calculations and integrated steps which are set in motion by initial values 14 and 16. Additionally, and for example, initial value 14 and output 46 can be temperature readings of a specific location and/or material. However, the value of output 46 may be significantly different than initial value 14 due to the fact that output 46 is dependent upon a series of integrated engineering calculations which are based in part upon initial value 14.

Outputs 46 and 48 are inputted into a decision node 50 which determines whether or not outputs 46 and 48 are sufficiently close to or converged with their respective initial input values 14 and 16. A range which represents a tolerance range that is acceptable between values 14 and 16 and outputs 46 and 48 can define the convergence of initial input values 14 and 16 to outputs 46 and 48.

If not, outputs 46 and 48 replace initial values 14 and 16 and engineering analysis process 10 is run again, however, outputs 46 and 48 are used instead of initial values 14 and 16. Engineering analysis process 10 is repeated until outputs 46 and 48 are determined to be at the desired value decision node 50. At this point, decision node 50 instructs engineering analysis process 10 to stop.

Since the process began with an initial assumption 18 it is almost certain that the first outputs 46 and 48 will not be within the predetermined tolerances.

As an alternative, and as required by the type of engineering analysis being performed, the number of subprocesses and their corresponding inputs and outputs may be varied.

A command code or module 52 communicates with each of the subprocesses and determines whether an input has been received and, accordingly, instructs the subprocess to run and provides designated output.

Accordingly, command code 52 determines which of the subprocesses to run and the sequence in which they are to be run. In addition, and as an alternative, command code 52 can be provided with boundary conditions, which set limits for each subprocess. Therefore, and if the result is outside the predetermined range, command code 52 will stop the analysis and request recalculation or new values to be inputted into the appropriate subprocess.

Integrated engineering analysis process 10 allows an engineer to run numerous simulations while varying the inputs in order to determine the effect on the final output. Attempting such a task in a situation where each of the subprocesses was a “stand alone” procedure would require many more calculations and comparisons which in comparison to the analysis process of instant application would be quite tedious and cumbersome, as well as involving a significant amount of additional time.

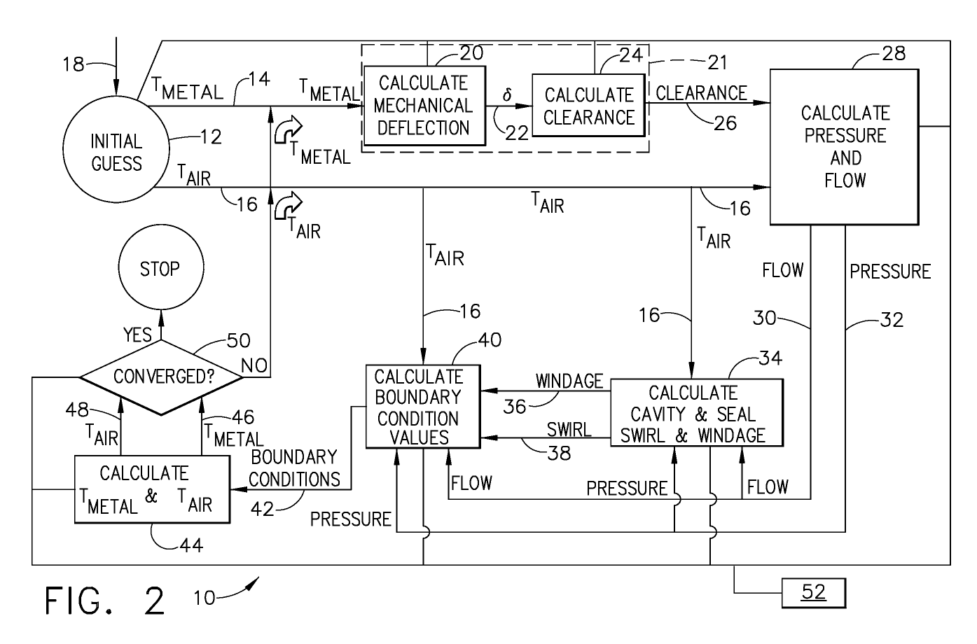

One contemplated use of the process is an integrated engineering analysis process with solution feedback for an aircraft engine design. This embodiment is illustrated in FIG. 2. Here initial guess or assumption 12 calculates air and metal temperatures (14, 16) for component parts of an aircraft engine in response to an initial assumption 18.

The metal temperature 14 is inputted into subprocess 20, which calculates the mechanical deflection of the metal components of an aircraft engine in response to the metal temperature 14. In addition to the metal temperature, and as will be discussed in more detail below, the engine speed, cavity pressures, and other forces influence the mechanical deflection of the metal components (subroutines 24, 28, 34, and 40). Using these subroutines, and their outputs, the mechanical deflection of the metal components is calculated. These boundary conditions can be applied to a mechanical model 21 (illustrated by the dashed lines in FIG. 2) that calculates the mechanical deflection. The boundary conditions can be applied directly to mechanical model 21 directly as needed by the integrated engineering analysis process 10.

Mechanical model 21 may use the same mesh as integrated engineering analysis process 10 model. When dissimilar meshes are used an added temperature mapping subprocess is required for integrated engineering analysis process 10. There are several potential differences between mechanical model 21 and analysis process 10 model. The mechanical model can be a subset of the analysis process 10 model if, for instance, the calculation of mechanical deflections is desired for only the metal components to be used in clearance calculations (subprocess 24). The mechanical model can include finite element modeling elements that are unique to stress-deflection calculations and not present in analysis process 10 model. It may require representation of features not required in analysis process 10 model, e.g. blades, bolts, and nuts. The mechanical model can include rotor and stator parts including components with different rotor speeds. When analysis process 21 uses a 2D model, special modeling techniques may be used to account for bolthole stiffness reductions and to reduce hoop-load strength for non-axisymmetric features. Special modeling techniques are also used to represent the airfoils in the mechanical model.

Here, output 22 of second subprocess 20 is the mechanical deflection value. It is noted, and for illustration purposes, that the mechanical deflection value 22 is dependent upon the temperature value 14 and other values such as engine speed and cavity pressures.

Output 22 is now inputted into subprocess 24 which in this embodiment calculates the resulting clearance between the mechanical parts (output 26). Again, and for purposes of illustration, it is noted that the clearance value is dependent upon the deflection value (output 22) of a mechanical part which in turn is dependent upon the metal temperature (initial value 14).

Output 26 and initial value 16 are now inputted into subprocess 28 which in this embodiment calculates flow and pressure values (outputs 30 and 32). Again, it is noted that the flow and pressure values are dependent upon the clearance and air temperature values.

Here it is of particular importance to note that output 26 is the result of three subprocesses (12, 20 and 24) while initial value 16 is the result of one subprocess 12.

As contemplated with the instant application, integrated engineering analysis process 10 is able to provide outputs (30 and 32) that are dependent upon inputs having origins of differing complexity.

As contemplated in the instant application, integrated engineering analysis process 10 and, in particular, the subprocess 28 provides two outputs 30 and 32 which are dependent upon the input of outputs 26 and 16, one of which is a result of three independent calculations.

Accordingly, integrated engineering analysis process 10 provides a problem solving approach wherein multiple results of simulations and/or equations having interdependent characteristics are accounted for in the final solution.

Referring back now to FIG. 2, initial value 16 and outputs 30 and 32 are now inputted into subprocess 34 which in this embodiment calculates the cavity and seal windage and swirl values (outputs 36 and 38).

Finally, initial value 16 and outputs 30, 32, 36, and 38 are inputted into subprocess 40 which will calculate the boundary condition values (output 42). These boundary conditions are now inputted into subprocess 44 in order to calculate outputs 46 (Tₘₑₜₐₗ) and 48 (Tₐᵢᵣ). It is noted that outputs 46 and 48 are comparable to initial values 14 and 16 respectively.

Decision node 50 determines whether or not outputs 46 and 48 are within predetermined tolerances. If so, the process is stopped, however, on the other hand if outputs 46 and 48 are not within the predetermined tolerances they are inputted into continuing analysis process 10 in place of initial values 14 and 16 and even tighter speculation is rerun with outputs 46 and 48 as the initial values. Therefore, the subprocesses of integrated and engineering analysis 10, dependent upon the prior said of outputs 46 and 48, will calculate a new set of outputs 46 and 48.

It is noted that in this embodiment the calculation of output values of many independent parameters are determined by an integrated manner which provides feedback among the various parameters or subprocesses so that all of the interdependencies are represented in the calculation of each of the values.

For example, and referring in particular to FIG. 2 which references an aircraft engine design problem, it is noted that the temperatures, and accordingly, the resulting values dependent upon these temperatures, will vary significantly as the engine moves from a non-operating temperature to an operational temperature.

Integrated engineering analysis process 10 in one embodiment provides a process for calculating the temperatures of components of turbomachinery. This process combines the calculation of metal temperatures with the calculation of cooling flow rates and temperatures including, the interdependent aspects of these physical processes. For example, the calculation of metal temperatures is combined with the calculation of cooling flow rates and temperatures and pressures and also the calculations of mechanical deflection as well as the interdependent aspects of these processes. These processes may also include the calculation of mechanical deflection of both a rotating feature and a stationary feature at a flow restriction. In addition, logic simulating control system regulation of controllable engine devices can also be incorporated into the calculation.

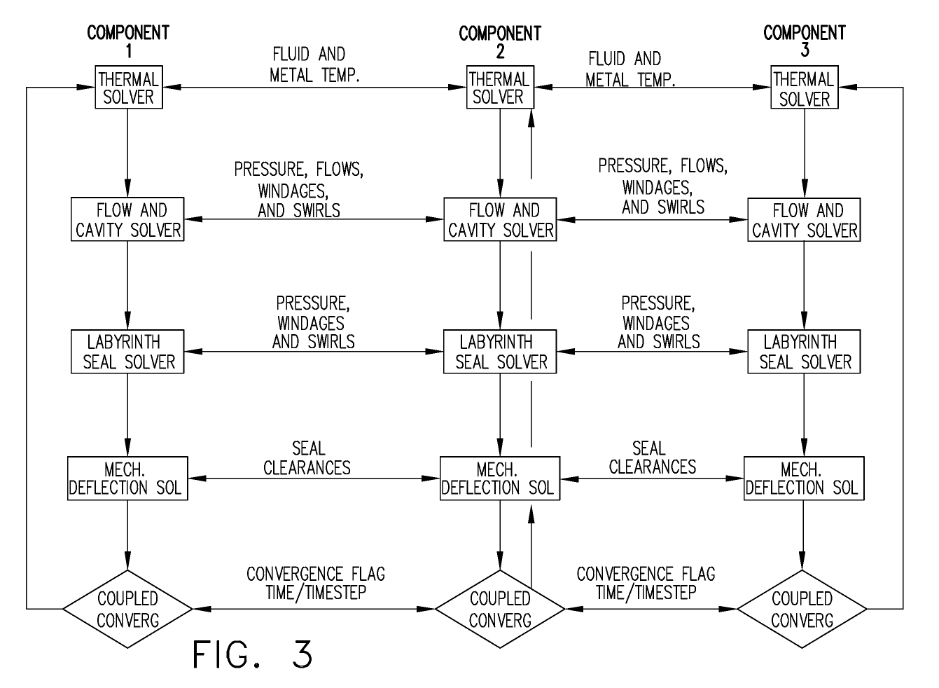

As shown in FIG. 3, a plurality (i.e., two or more) integrated processes such as described above are performed concurrently on a plurality of components to be designed via a fully integrated system and process. For example, in the embodiment of FIG. 3, three components are computationally analyzed, each with a plurality of individual solvers which are fully integrated both within a component and also between adjacent components. The computed results of each solver are communicated back and forth between all neighboring solvers of all models to be using, for example, message passing interface (MPI) protocols to obtain a fully coupled convergence. Therefore, no one model will converge in a standalone sense, thus assuring that all of the interdependencies are accounted for in a consistent and accurate manner. This approach provides improved computational efficiency and accuracy, and permits simulations to be performed of the behavior and performance of multiple adjacent components. When employed to perform computations for the modules of an aircraft gas turbine engine, for example, an analysis of the performance of the engine may be performed.

Thus, an integrated automatic, real-time process for thermal analysis, flow analysis, cavity (windage and swirl) analysis, labyrinth seal analysis, mechanical deflection analysis, and clearance analysis is provided. Moreover, there is communication between the various elements in the integrated process of the instant application. In addition, and as an alternative, the hierarchy of integrated analysis process 10 can be altered to accommodate various design features and/or scenarios.

Moreover, these temperatures will vary as the engine is exposed to differing altitudes and weather conditions. Therefore, the analysis process of the instant application allows a designer to predict such variations as the analysis process of the instant application accounts for such interdependencies which, in turn, allows the design to account for such variations.

It is also contemplated that the number of subprocesses may be increased or decreased. In addition, the output and accordingly input pathways to and from each of the subprocesses may also be varied. Moreover, the number of output and input pathways may also be varied.

Of course, the number of subprocesses and their interconnections is dependent upon the type of engineering analysis process being performed. For example, the instant application discusses one aspect of an aircraft engineering analysis process, however, the process of the instant application is not intended to be limited to the same and may be utilized with any design process.

The integrated engineering analysis of the instant application provides accurate accounting and representation of the interdependent values. This results in high-quality predictions. For example, steady-state and transient temperature levels and distributions vary significantly and are dependent upon other values. The process of the instant application provides accurate predictions of the same which allows multiple interdependent outputs to be determined without having to rely on traditional “stand alone” calculations.

This process provides a more streamlined analysis technique which permits more cases, scenarios or problems to be analyzed in less time and at less cost.

There is also less opportunity for errors or miscalculations as the results of the various subprocesses are accounted for when calculating single values which in themselves vary.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An integrated engineering analysis system, comprising:
a) a first integrated computational process, said first process being comprised of a plurality of computational solvers adapted to compute characteristics of a first component;
b) a second integrated computational process, said second process being comprised of a plurality of computational solvers adapted to compute characteristics of a second component; and
c) communication paths between corresponding computational solvers of said first and second computational processes.

2. The system of claim 1, wherein said communication paths are comprised of message passing interfaces (MPIs).

3. The system of claim 1, wherein said system is configured to be used in conjunction with an aircraft engine engineering design.

4. The system of claim 1, wherein said system calculates the deflection values of component parts of an aircraft engine.

5. The system of claim 1, wherein said system calculates the deflection values of movable and stationary component parts of an aircraft engine.

6. The system of claim 5, wherein said system also calculates air pressure and flow of an aircraft engine.

7. The system of claim 1, wherein said characteristics vary in accordance with temperature.

8. The system of claim 1, wherein said system is configured to be used in conjunction with a design that has mechanical parts which are temperature sensitive.

9. The system of claim 1, wherein said system includes a command code configured to determine whether a final output is within a predetermined range.

10. The system of claim 1, wherein said system comprises three or more integrated computational processes, each of said processes being comprised of a plurality of computational solvers adapted to compute characteristics of a respective component, and wherein communication paths connect corresponding computational solvers of said processes.

11. An integrated engineering analysis system, comprising:
a) a plurality of integrated computational process, each of said processes being comprised of a plurality of computational solvers adapted to compute characteristics of an aircraft engine component;
b) communication paths comprised of message passing interfaces (MPIs) between corresponding computational solvers of said plurality of computational processes; and
c) a command code configured to determine whether said characteristics have converged within a specified range.
